(19) United States
(12) Patent Application Publication
(10) Pub. No.: US 2025/0256913 A1
(43) Pub. Date: Aug. 14, 2025

(54) Food Dispenser

(71) Applicant: Eden Eisner, Ridgefield, CT (US)

(72) Inventor: Eden Eisner, Ridgefield, CT (US)

(21) Appl. No.: 19/048,068

(22) Filed: Feb. 7, 2025

Related U.S. Application Data
(60) Provisional application No. 63/551,605, filed on Feb. 9, 2024.

(51) Int. Cl. B65D 83/761; B65D 47/04

(52) U.S. Cl. CPC B65D 83/761; B65D 47/043

(57) ABSTRACT

A dispenser for frosting or other semi-solid food products, with a lower dispensing base, an upper dispensing base capable of containing the food product, an impeller platform, and a dispensing top with a plurality of openings or apertures. The impeller platform is capable of movement toward the dispensing top. A spreader is attached to the dispensing top to assist in dispensing the food product.

### PRIORITY

This application claims domestic benefit from pending provisional application No. 63/551,605, filed Feb. 9, 2024, and which is incorporated by reference.

### FIELD OF INVENTION

The invention is in the field of household dispensers, in particular, dispensers for food products such as condiments and baking ingredients.

### BACKGROUND

The inventor loves baking and often enjoys making cupcakes with family and friends. The inventor noticed that young children had considerable enthusiasm for frosting cupcakes but made a terrible mess. If the children attempted to use a knife to spread the frosting, they were often too heavy-handed and damaged the cake, or were wasteful and got frosting everywhere. If the children used a pastry bag (or at-home modified Ziploc® bag version), the desire to squirt the frosting or simply suck it out of the bag directly into their mouths proved too tempting, resulting in messes and even more wasted frosting. The inventor believed there must be a way to allow children to participate in this common baking activity that was less messy and wasteful, and decided to explore solutions.

One inspiration for a stick-like frosting dispenser was derived from sunscreen applicators in a stick form, which did not present difficulties to young children. A sunscreen stick cleaned and refilled with frosting was attempted, but did not work well. The frosting was not solid enough and would flop off in a blob and fall once a certain amount of frosting had been dispensed, but before the stick was inverted for application of the frosting. This did not address the concern of wasted frosting.

The sunscreen stick was also found to be too narrow, therefore requiring a tall but narrow amount of dispensed frosting to cover a cupcake. The narrowness of the stick was also annoying to the young user because it required a lot of wheel-turning to raise the inner container floor of the stick. A subsequent test used a larger, but structurally-similar container: stick deodorant. This larger vessel proved to reduce considerably the amount of time and effort on the part of the user in order to dispense a suitable amount of frosting. Despite the improvement of the larger dispensing surface, the frosting would frequently topple over and off the unit before dispensing. Better results were achieved to reduce toppling with the use of a deodorant canister lid that was perforated with small holes throughout the lid rather than one which had solid line openings across the lid.

The inventor realized that the recurring issue of the frosting dropping off the dispensing surface prior to application would persist without something to provide support for the dispensed amount prior to application. One attempted solution involved attaching a piece of plastic to one side of the deodorant stick lid, which effectively held the frosting in place. However, when the unit was inverted for dispensing frosting onto the cake, the hard plastic would apply the frosting too firmly, scraping it unevenly as it moved.

This led to the realization that a spreader needed to be composed of a material that was firm enough to hold the frosting but also pliable enough to act as a gentle spreader. A commonly used material for baking utensils is silicone, which rarely damages cakes or cupcakes. Silicone baking cups or silicone pans are known to provide pliable bakeware. Cutting pieces of silicone baking cups and adhering the cut pieces to the deodorant sticks resulted in an implement that held the frosting and spread it extremely well.

At this point in development, the inventor understood that she had the right basic design and materials, but needed to refine the dispenser. She realized that for speed and case, and also to meet the needs of the target user, a young child, at their level of dexterity, it would be ideal if the silicone spreading implement cleanly spread the frosting without requiring many strokes. The more effort that needed to be expended on each cupcake, the more likely a small child would begin to experience user-specific performance variances based on individual pressure and speed. Accordingly, she experimented with different heights and shapes of silicone pieces to optimize the speed and uniformity of the spreading, aiming for 2-3 strokes maximum per cupcake. In making her prototypes, she utilized the height and shape that performed the best in her experiments. It should be noted that the inventor ran silicone spreader experiments with a variety of frosting types and did note performance differences across the various permutations of types/heights/shapes. She promoted to her prototype the overall best performing silicone model across all frosting viscosities.

An important motivation in creating the design was creating something reusable, which requires easy assembly/disassembly and cleaning.

### SUMMARY

The invention is a dispenser for frosting or other semi-solid food products, with a lower dispensing base, an upper dispensing base capable of containing the food product within a cavity, the upper dispensing base including a dispensing top with a plurality of openings or apertures, an impeller platform, means for moving the impeller platform, such as an elongated screw threaded drive shaft, and a spreader attached to the dispensing top. The elongated screw threaded drive shaft extends from the impeller platform to a wheel in the lower dispensing base, where rotation of the wheel turns the threaded drive shaft, thereby moving the impeller platform in a direction toward or away from the dispensing top.

### BRIEF DESCRIPTION OF THE DRAWINGS

FIG. 1 is an exploded view of a preferred embodiment of the dispenser.

FIG. 2 is a front perspective view of an alternate embodiment of the dispenser.

FIG. 3 is a front perspective view of a second alternate embodiment of the dispenser.

FIG. 4 is a front perspective view of a third alternate embodiment of the dispenser.

FIG. 5 is a top perspective view of an embodiment of the dispenser.

FIG. 6 is a front view of an alternate embodiment of the dispenser.

FIG. 7 is a front view of a fourth alternate embodiment of the dispenser.

FIG. 8 is an exploded front view of the top of the alternate embodiment of the dispenser shown in FIG. 7.

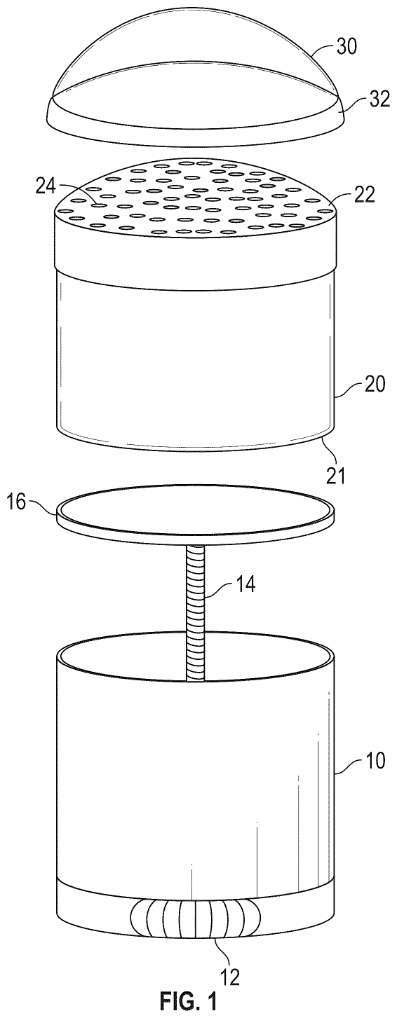

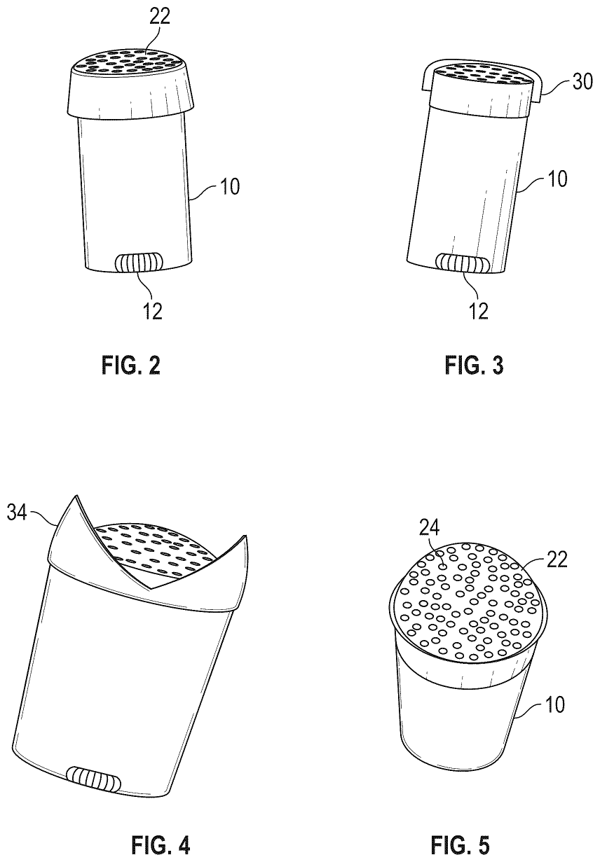

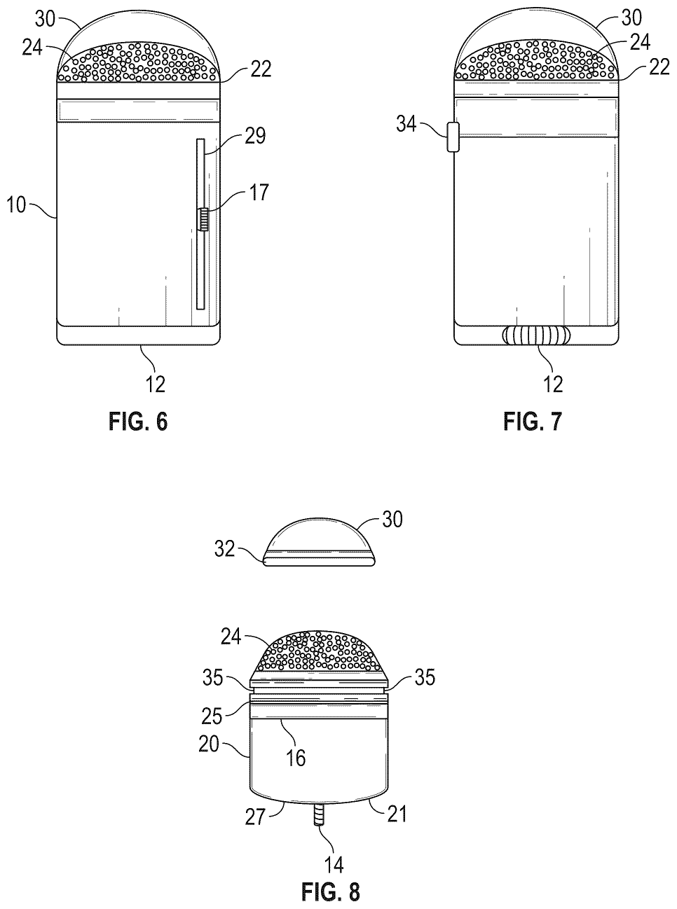

### DETAILED DESCRIPTION

The invention preferably consists of an upper dispensing base 20, which has a cavity 21 capable of holding a semi-solid food product. The upper dispensing base 20 has an opening 27 to allow loading the food product, and opposite the opening 27 is a dispensing top 22 with a at least one aperture 24 to allow for the controlled dispensing of the food product. Adjacent to the dispensing top 22 is a spreader 30, allowing for controlled spreading of the dispensed food product onto a separate surface.

The dispensing top 22 may be formed in any of a variety of shapes. For the purpose of applying the food product to a large area, such as using the dispenser for frosting a cake, it may be desired that the dispensing top 22 have a longer width than depth. For other uses, such as applying frosting to small cupcakes, the dispensing top 22 may be circular to match the size and shape of the cupcake top. The overall appearance of the dispensing top may be round, elliptical, rectangular, square, or any other shape.

In a preferred embodiment, there are a plurality of apertures 24 in dispensing top 22. The plurality of apertures may be evenly distributed across dispensing top 22. Alternate embodiments include a single elongated linear aperture, a plurality of elongated linear apertures, or one or more apertures shaped in artistic designs.

There is a lower dispensing base 10 with an impeller platform 16. The impeller platform 16 is capable of movement in a direction perpendicular to the dispensing top 22. The movement of the impeller platform 16 is preferably controlled at the lower dispensing base.

In a preferred embodiment, the movement of the impeller platform 16 is controlled by an elongated threaded shaft 14, where rotation of the elongated threaded shaft 14 drives the impeller platform 16 in a direction parallel to the elongated threaded shaft. The preferred embodiment also includes a wheel 12 that engages with and rotates the elongated threaded shaft 14, where the wheel 12 is located at the bottom of the lower dispensing base 10. The impeller platform 16 engages the elongated threaded shaft 14, where the rotation of the elongated threaded shaft 14 translates to movement of the impeller platform 16 relative to the elongated threaded shaft 14.

In an alternate embodiment, a slot 29 is provided along a side of upper dispensing base 20, and impeller platform 16 includes an extending tab 17, which extends through slot 29. A user may move impeller platform 16 by sliding extending tab 17 up or down with respect to upper dispensing base 20.

The impeller platform 16 preferably fits snugly within the cavity 21 of the upper dispensing base 20, so that movement of the impeller platform 16 drives a food product within the cavity 21 toward the apertures 24 of dispensing top 22, for dispensing the food product through the apertures 24. Impeller platform 16 and cavity 21 preferably have a substantially similar shape, such that the movement of impeller platform 16 within cavity 21 moves the food product, preferably leaving little or no food product remaining on the inner walls of upper base 20 within cavity 21.

After the food product has traveled through the apertures 24 of dispensing top 22, a user may apply the food product to a desired surface. A spreader 30 is attached to the dispensing top 22, to assist in the uniform application of the food product to the desired surface. Spreader 30 functions similar to how a spatula or knife blade may also be conventionally used to dispense food products.

The spreader 30 is preferably located along one side of the dispensing top 22, but alternate embodiments could include surrounding the entire dispensing top 22, or any portion thereof. Where the dispensing top 22 is formed with an elliptical or rectangular shape, the spreader 30 preferably extends a long side of the dispensing top 22. A variation of spreader 30 is shown in FIG. 4 as a two part spreader 34.

The spreader 30 may be permanently attached to the dispensing top, or may be removable. It is anticipated that a removable spreader 30 may be desired for ease of cleaning. For a removable embodiment, the spreader 30 may be attached by an elastic loop 32 capable of surrounding dispensing top 22.

In a preferred embodiment, the food product would be placed directly inside cavity 21, to avoid the use of a disposable plastic bag or similar soft container and to reduce potential waste, however, an internal bag or container may be used in some embodiments.

The preferred embodiment assembles easily and quickly and the component parts are designed to be easy to clean. For easier disassembly, tabs or flanges may be provided where the upper base and lower base connect.

A preferred embodiment would include a built-in tab or button to assist in opening the dispensing base to allow cleaning and insertion of the food product. Ideally, this would be easy enough for any user to perform, but hard to press or hit accidentally, to avoid usage accidents. There would still be a generous overlap between the lid and canister, to ensure a perfect seal and to reduce the likelihood of the closing mechanism pinching fingers.

While an adhesive may be used to attach the silicone spreader to the lid, a very vigorous cleaning or cleaning over a long period might deteriorate the adhesive bond. To increase longevity and user confidence in a clean unit, a preferred embodiment would allows for spreader 30 to be removed and cleaned separately from dispensing top 22. One embodiment could provide that the release mechanism used to separate upper base 20 and lower base 10 could also release spreader 30.

In another embodiment, support loop 32 is connected to spreader 30, where support loop 32 surrounds dispensing top 22. Preferably support loop 32 is elastic to allow for easy removal and attachment of spreader 30. Notch 35 may be provided around dispensing top 22 for engagement with support loop 32.

These optional features could also permit a user to own and deploy multiple different spreaders, fashioned to accommodate different types of frostings or different condiments or soft-solid foods generally.

In alternate embodiments, apertures 24 could comprise various shapes and sizes, depending on the nature of the food product being dispensed. Such shapes and sizes include horizontal bars, stars, circles, arcs, or other designs which can allow for user creativity.

While the initial intent of the invention was solving for a small child user and for baking, the unit could be used with other food items and in other contexts. An easy, eco-friendly dispenser/spreader also appeals to adults, including adults with certain conditions (like arthritis) and different abilities. The dispenser base might be made larger or smaller to accommodate these different contexts; the deodorant stick size fits nicely in a child's hand and was not too heavy. Seeing as adults actually use deodorant sticks with ease, a similar unit size would not be prohibitively small for a bigger user.

In an alternate embodiment, wheel 12 could comprise a clicking wheel mechanism where an adult helping a child with baking could instruct the child to use a certain number of clicks, simplifying success without sacrificing independence and further reducing mess and waste. However, a press-button or sliding lever to control the movement of dispensing top 22 could work well or perhaps even be preferred for an adult or older child that could more accurately determine the dispensed amount with consistent accuracy.

While certain novel features of the present invention have been shown and described, it will be understood that various omissions, substitutions and changes in the forms and details of the device illustrated and in its operation can be made by those skilled in the art without departing from the spirit of the invention.

I claim:

1. A food dispenser comprising:
an upper dispensing base comprised of a dispensing top with a perimeter and a wall extending from the perimeter,
where the dispensing top is comprised of at least one aperture, and
where the wall surrounds a cavity formed by the wall and the dispensing top;
an impeller platform capable of fitting within the cavity of the upper dispensing base; and
a lower dispensing base, the lower dispensing base comprising means for moving the impeller platform within the upper dispensing base in a direction toward the dispensing top.

2. The food dispenser of claim 1, further comprising:
a spreader attached to the dispensing top.

3. The food dispenser of claim 2, where the spreader extends along a side of the dispensing top.

4. The food dispenser of claim 1, where the means for moving the impeller platform comprises:
a wheel at the lower dispensing base; and
an elongated threaded cylinder with a first end attached to the impeller platform and a second end attached to the wheel,
where the rotation of the wheel causes the rotation of the elongated threaded cylinder, and where such rotation causes the movement of the impeller platform relative to the lower dispensing base.

5. The food dispenser of claim 1, where the means for moving the impeller platform comprises:
an elongated opening extending along a side of the lower dispensing base; and
an extension on a side of the impeller platform, where an end of the extension extends out of the elongated opening.

6. The food dispenser of claim 1, further comprising:
a plurality of apertures on the dispensing top.

7. The food dispenser of claim 2, where the spreader further comprises:
a spreading edge; and
an attachment edge, where the attachment edge is proximate to the dispensing top.

8. The food dispenser of claim 6, further comprising:
an elastic loop connected to the attachment edge, the elastic loop capable of extending around the dispensing top.

9. The food dispenser of claim 7, further comprising:
a notch extending around the dispensing top, where the elastic loop engages the notch.
